(19) United States
(12) Patent Application Publication
(10) Pub. No.: US 2025/0266563 A1
(43) Pub. Date: Aug. 21, 2025

(54) BATTERY PACK HAVING BLOW-OUT VALVE

(71) Applicant: FCA US LLC, Auburn Hills, MI (US)

(72) Inventors: Daniel J. Summers, Royal Oak, MI (US); Richard J. Scorzelli, Fowlerville, MI (US)

(21) Appl. No.: 18/583,332

(22) Filed: Feb. 21, 2024

(51) Int. Cl. H01M 50/342; H01M 50/204; H01M 50/249

(52) U.S. Cl. CPC H01M 50/3425; H01M 50/204; H01M 50/249; H01M 2220/20

(57) ABSTRACT

A valve including an annular base defining a through-hole, a hollow throat section having a proximate end connected to the annular base at the through-hole and a distal end located away from the annular base, and a plurality of flexible members attached to the distal end that are configured to mate together to seal the aperture when the valve is in a closed position and configured to separate when the valve is in an open position. The plurality of flexible members are configured to separate when a pressure within the battery pack reaches a predetermined threshold, and in a closed position of the valve, the hollow throat section including the flexible members extends away from the through-hole in a negative z-direction, and in an open position of the valve the hollow throat section including the flexible members extend away from the through-hole in a positive z-direction.

### FIELD

The present disclosure relates to battery back having a blow-out valve.

### BACKGROUND

This section provides background information related to the present disclosure which is not necessarily prior art.

Vehicles with electric propulsion systems are becoming increasingly more common. Some electrically propelled vehicles include an electric drive motor at each wheel of the vehicle, and some electrically propelled vehicles include a front electric drive motor for rotating the front wheels of the vehicle and a rear electric drive motor for rotating the rear wheels of the vehicle. In either case, the electric drive motors receive power from a battery pack that includes a plurality of battery cells therein. Example battery cells include lithium-ion battery cells and lithium-metal battery cells.

Lithium-ion and lithium-metal battery cells sometimes undergo a process called thermal runaway during failure conditions. Thermal runaway may result in a rapid increase of battery cell temperature accompanied by the release of various gases, which, in turn, rapidly increase the pressure inside a battery housing. Accordingly, in the event of a thermal runaway, it is desirable that the vehicle include features that assist in the ventilation of the volatile gases that may otherwise increasingly pressurize the battery housing.

### SUMMARY

This section provides a general summary of the disclosure, and is not a comprehensive disclosure of its full scope or all of its features.

According to a first aspect of the present disclosure, there is provided a valve configured for use with a battery pack having a discharge vent for discharging gases from the battery pack, the valve comprising an annular base located proximate the discharge vent and defining a through-hole; a hollow throat section having a proximate end connected to the annular base at the through-hole and a distal end located away from the annular base; and a plurality of flexible members attached to the distal end that are configured to mate together to seal the aperture when the valve is in a closed position and configured to separate when the valve is in an open position, wherein the plurality of flexible members are configured to separate when a pressure within the battery pack reaches a predetermined threshold, and in a closed position of the valve, the hollow throat section including the flexible members extends away from the through-hole in a negative z-direction, and in an open position of the valve the hollow throat section including the flexible members extend away from the through-hole in a positive z-direction.

According to the first aspect, each of the plurality of flexible members include edges that are configured to mate and form an interlocked seal when the valve is in the closed position.

According to the first aspect, the edges separate to open the interlocked seal when the valve is in the open position.

According to the first aspect, the predetermined threshold to open the valve is about 100 millibars.

According to the first aspect, each of the annular base, the throat section, and the plurality of flexible members are formed of an elastomeric material.

According to the first aspect, the elastomeric material is selected from the group consisting of a natural or synthetic rubber material, a silicone material, and polyurethane material.

According to the first aspect, each of the annular base, the throat section, and each of the plurality of flexible members form a monolithic structure.

According to a second aspect of the present disclosure there is provided a battery pack comprising a housing configured to support a plurality of battery cells; a plurality of discharge vents that are configured to discharge gases generated by at least one of the plurality of battery cells; and a valve provided in each of the discharge vents that is configured to open to permit the discharge gases to escape the housing through each of the discharge vents, wherein each of the valves includes an annular base located proximate the discharge vent and defining a through-hole; a hollow throat section having a proximate end connected to the annular base at the through-hole and a distal end located away from the annular base; and a plurality of flexible members attached to the distal end that are configured to mate together to seal the aperture when the valve is in a closed position and configured to separate when the valve is in an open position, wherein the plurality of flexible members are configured to separate when a pressure within the battery pack reaches a predetermined threshold, and in a closed position of the valve, the hollow throat section including the flexible members extends away from the through-hole in a negative z-direction, and in an open position of the valve the hollow throat section including.

According to the second aspect, each of the plurality of flexible members include edges that are configured to mate and form an interlocked seal when the valve is in the closed position.

According to the second aspect, the edges separate to open the interlocked seal when the valve is in the open position.

According to the second aspect, the predetermined threshold to open the valve is about 100 millibars.

According to the second aspect, each of the annular base, the throat section, and the plurality of flexible members are formed of an elastomeric material.

According to the second aspect, the elastomeric material is selected from the group consisting of a natural or synthetic rubber material, a silicone material, and polyurethane material.

According to the second aspect, each of the annular base, the throat section, and each of the plurality of flexible members form a monolithic structure.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view of a vehicle according to a principle of the present disclosure;

FIG. 2 is a perspective view of an example battery pack of the vehicle illustrated in FIG. 1;

FIG. 3 is a perspective view of an example blow-out valve in a closed position according to a principle of the present disclosure;

FIG. 4A is a cross-sectional view of the example blow-out valve in an open position;

FIG. 4B is a cross-sectional view of the example blow-out valve in a closed position;

FIG. 5A is a schematic cross-sectional representation of the example blow-out valve in a closed position when no pressure is being exerted thereon to open the blow-out valve;

FIG. 5B is a schematic cross-sectional representation of the example blow-out valve in a closed position when pressure is beginning to be exerted thereon to open the blow-out valve;

FIG. 5C is a schematic cross-sectional representation of the example blow-out valve in an open position when the pressure was exerted to an extent that opened the blow-out valve; and

FIG. 5D is a schematic cross-sectional representation of the example blow-out valve in an open position where the pressure within the battery pack has been expelled.

Corresponding reference numerals indicate corresponding parts throughout the several views of the drawings.

### DETAILED DESCRIPTION

Example embodiments will now be described more fully with reference to the accompanying drawings. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

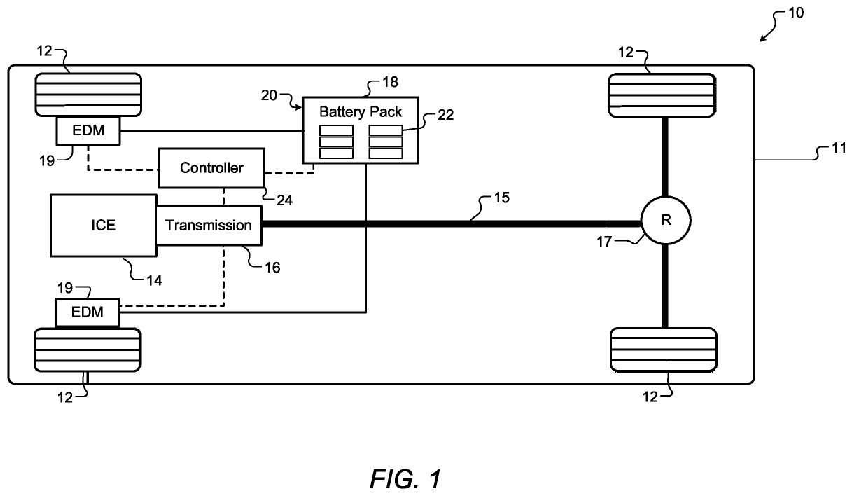

FIG. 1 schematically illustrates an example vehicle 10 according to the present disclosure. The example vehicle 10 includes a body 11 and a plurality of wheels 12. In the illustrated embodiment, each front wheel 12 may be driven using a respective electric drive module 19 that receives electric power from a battery pack 18 having a housing 20 that encases a plurality of battery cells 22. Thus, vehicle 10 may be a battery-powered electric vehicle. Example battery cells 22 include lithium-ion battery cells, lithium-metal battery cells, and combinations thereof. It should be understood, however, that other types of battery cells 22 known to one skilled in the art may be used, without limitation. Housing 20 is preferably formed of a rigid metal material (e.g., steel, aluminum, and the like) that is resistant to puncture and is non-flammable.

While the vehicle 10 is described above as being an electric vehicle, it should be understood that the teachings of the present disclosure can also be applicable to a hybrid vehicle having, in addition to the electric drive modules 19, an internal combustion engine 14 and transmission 16 for providing power to rear wheels 12 via a driveshaft 15 that is connected to a differential 17 that is connected to the rear wheels 12.

FIG. 1 illustrates two electric drive modules 19 such that each front wheel 12 can be driven by a single electric drive module 19. It should be understood, however, that vehicle 10 may include a single electric drive module 19 for driving a pair of wheels 12 (e.g., for driving the pair of front wheels 12 or the pair of rear wheels 12), or may include a pair of electric drive modules 19 with one of the electric drive modules 19 driving the front pair of wheels 12 and another of the electric drive modules 19 driving the rear pair of wheels 12. Regardless of the configuration selected, it should be understood that electric drive modules 19 receive a voltage or current from battery pack 18 that is utilized by the electric drive module 19 to drive the wheels 12 of the vehicle 10.

Vehicle 10 may also include a controller 24 in communication with each of the drive modules 19 and in communication with the battery pack 18. Controller 24 may be used to control electric drive modules 19 to control a speed of vehicle 10, and may also be used to monitor and/or communicate with various systems of vehicle such as, for example, an HVAC system (not shown), a vehicle braking system (not shown), and any other system that may be part of vehicle 10.

As noted above, battery cells 22 may sometimes undergo a process called thermal runaway during failure conditions of the battery cell(s) 22. Thermal runaway may result in a rapid increase of battery cell 22 temperature accompanied by the release of various gases. Example gases that may be released during a thermal runaway event include hydrogen (H₂), carbon monoxide (CO), carbon dioxide (CO₂), and various hydrocarbons including, but not limited to, methane, ethane, ethylene, acetylene, propane, cyclopropane, and butane. As these gases are released and the temperature of battery pack 18 increases, the pressure within battery pack 18 also increases.

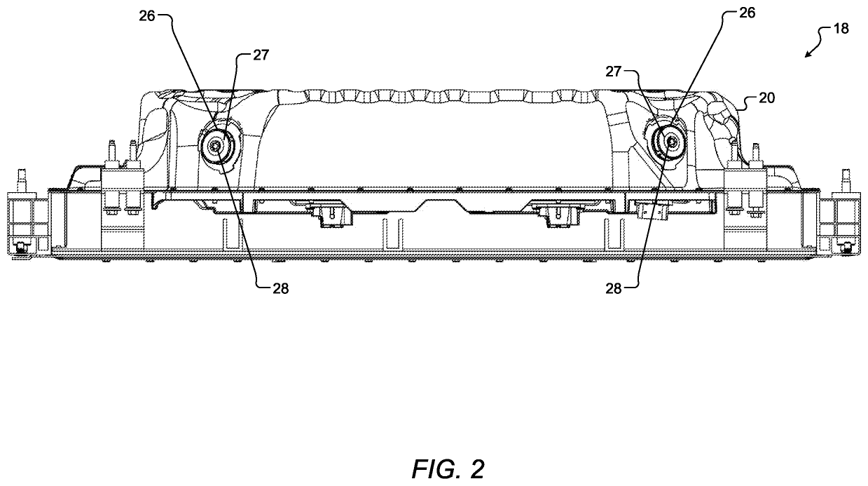

Now referring to FIG. 2, it can be seen that housing 20 of battery pack 18 includes a plurality of discharge vents 26 that permit the pressure and gases to escape housing 20 during a thermal runaway event. In this regard, discharge vents 26 may each include a blow-out valve 28 that is closed when a pressure in the housing 20 is below a predetermined pressure, and that is configured to open when the predetermined gas pressure is generated within housing 20. Blow-out valve 28 is a one-way valve that only permits gases to exit housing 20 when the predetermined pressure is generated in housing 20.

For example, if the pressure within housing 20 reaches 100 millibars the blow-out valve 28 is configured to open and permit the gases within housing 20 to exit the battery pack 18 through discharge vent 26. Discharge vents 26 may be in communication with various conduits (not shown) located in battery pack 18, which direct the gases generated during the thermal runaway event to the discharge vents 26 and the blow-out valves 28 to be expelled from battery pack 18. While only a pair of discharge vents 26 having blow-out valves 28 are illustrated in FIG. 2, it should be understood that battery pack 18 may include a greater number of discharge vents 26 having blow-out valves 28 without departing from the scope of the present disclosure.

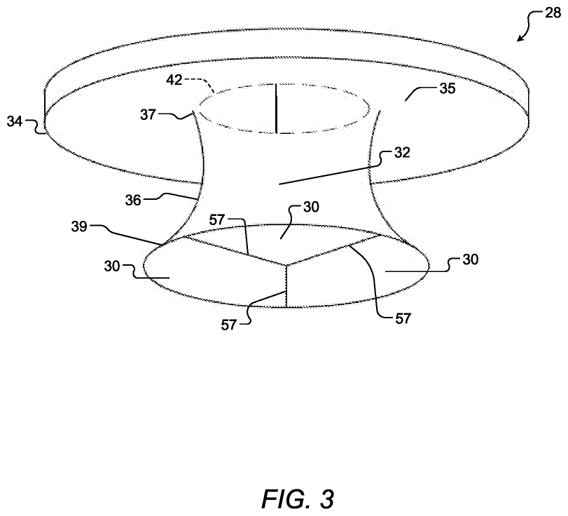

FIG. 3 illustrates an example blow-out valve 28 according to a principle of the present disclosure in the closed position. Blow-out valve 28 may be formed (e.g., molded) from an elastomeric material that is capable of deforming under pressure and returning to its original shape. Example elastomeric materials include, but are not limited to, natural or synthetic rubber materials, silicone materials, and polyurethane materials.

As illustrated in FIG. 3, the blow-out valve 28 is formed (e.g., molded) as a continuous and unitary structure that may include an annular base 34 and a hollow throat section 36 defining a channel 32 extending outward from the annular base 34. FIG. 3 illustrates blow-out valve 28 in a closed position. Annular base 34 includes an abutment surface 35 that is configured to abut against an annular surface 27 of discharge vent 26, while throat section 36 is configured to be received within an elongated passage (not shown) provided in discharge vent 26. Throat section 36 is configured to receive gases from an interior of battery pack 18 when a pressure within the interior of the battery pack 18 reaches a certain level (e.g., 100 millibars) that is sufficient to force a plurality of flexible members 30 to spread apart from each other and open the blow-out valve 28, as will be described in more detail below.

Throat section 36 includes a first or proximate end 37 attached to annular base 34 at a through-hole 42 that permits gases to escape discharge vents 26 when blow-out valve 28 is open, and an opposite second or distal end 39 that includes, in the illustrated embodiment, three flexible members or flaps 30. When blow-out valve 28 is closed, the flexible members 30 are in contact with each other as shown in FIG. 3 to form an interlocking seal at the distal end 39 that provides a fluid-tight barrier, and when blow-out valve 28 is open the flexible members 30 disengage from each other to open the blow-out valve 28 and permit the pressure within battery pack 18 to escape the discharge vent 26. While three flexible members 30 are illustrated, it should be understood that the blow-out valve 28 may include a greater or lesser number of flexible members 30, if desired. In any event, it should be understood that the structure of blow-out valve 28 enables flexible members 30 to be re-closed (i.e., but back into contact with each other) to re-use the blow-out valve 28 after gases have escaped from battery pack 18.

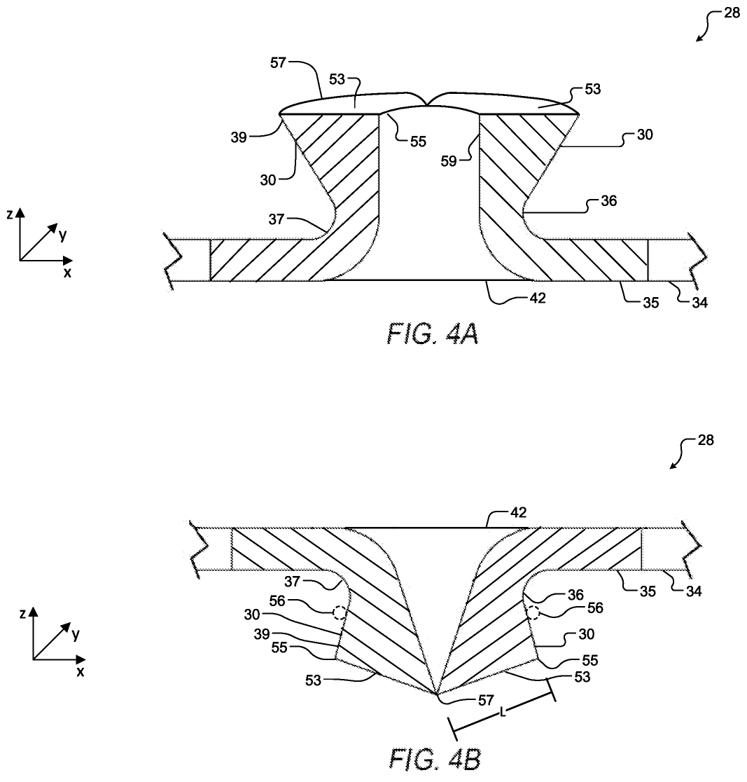

Now referring to FIGS. 4A and 4B, blow-out valve 28 is illustrated in the open (FIG. 4A) and closed (FIG. 4B) positions. FIG. 4A illustrates the blow-out valve 28 in an “as-molded” condition where blow-out valve 28 is open, and FIG. 4B illustrates the blow-out valve 28 in an “inverted” and closed position where throat 36 and flexible members 30 are pressed through aperture 42 such that flexible members 30 are engaged with each other to form the interlocking seal. To assist in maintaining flexible members 30 in engagement when blow-out valve 28 is closed, a biasing ring or garter spring 56 may be placed about an outer perimeter of the throat 36.

As shown in FIG. 4A, flexible members 30 extends outward from annular base 34 in the positive z-direction when blow-out valve 28 is open. When blow-out valve 28 is closed as shown in FIG. 4B, flexible members 30 and throat 36 are inverted to extend outward from annular base 34 in the negative z-direction. When flexible members 30 and throat 36 are inverted, an outer radial surface 57 of a respective flexible member 30 will contact the outer radial surfaces 57 of the other flexible members 30 to form the interlocked seal shown in FIG. 3. When flexible members 30 are in the open position (FIG. 4A), an inner radial surface 55 of the flexible members 30 collectively define a cylindrical outlet 59 that permits gases to escape blow-out valve 28.

Flexible members 30 each include a planar surface 53 that, when blow-out valve 28 is in the closed position, can be impinged upon by the gases that may develop during a thermal runaway event. Once the force exerted by the gases on planar surface 53 has reached a predetermined threshold (i.e., 100 millibars), flexible members 30 may be forced in the positive z-direction where outer radial surfaces 57 disengage from each other and blow-out valve 28 is opened (FIG. 4A). Flexible members 30 include planar surface 53 because a thickness of flexible members 30 increases from first end 37 to second end 39.

As noted above, blowout valve 28 may optionally include a garter spring 56 (shown in FIG. 4B) that can prevent blowout valve 28 from unnecessarily opening when in the inverted (i.e., closed) position. In this regard, if a negative pressure were to develop within battery pack 18, a positive pressure located exterior to battery pack 18 may be sufficient to partially push outer radial surfaces 57 of flexible members 30 away from each other and permit ambient air, dust, and/or moisture to enter into the housing 20. Due to the presence of garter spring 56, however, the interlocked seal between the flexible members 30 in the closed position is maintained. The garter spring 56 may be formed from an elastomeric material, metal, or a combination of both. The garter spring 56 may wrap around the interlocked flexible members 30 and exert an inward radial force upon the flexible members 30 that maintains blowout valve 28 in the closed position when a negative pressure exists in housing 20.

It should be understood that garter spring 56 does not prevent blowout valve 28 from opening upon reaching the predetermined threshold pressure described above. Indeed, garter spring 56 is designed to naturally slip off the blow-out valve 28 when flexible members 30 move from the closed to the open position.

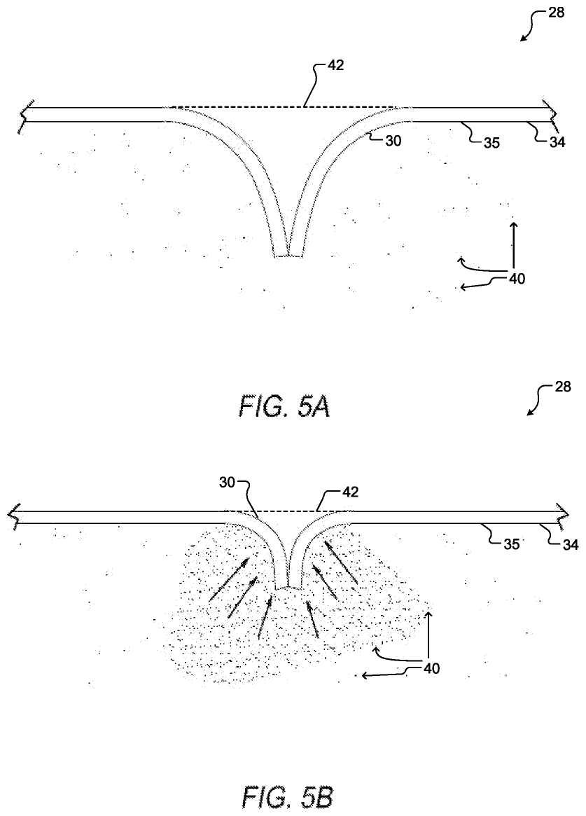

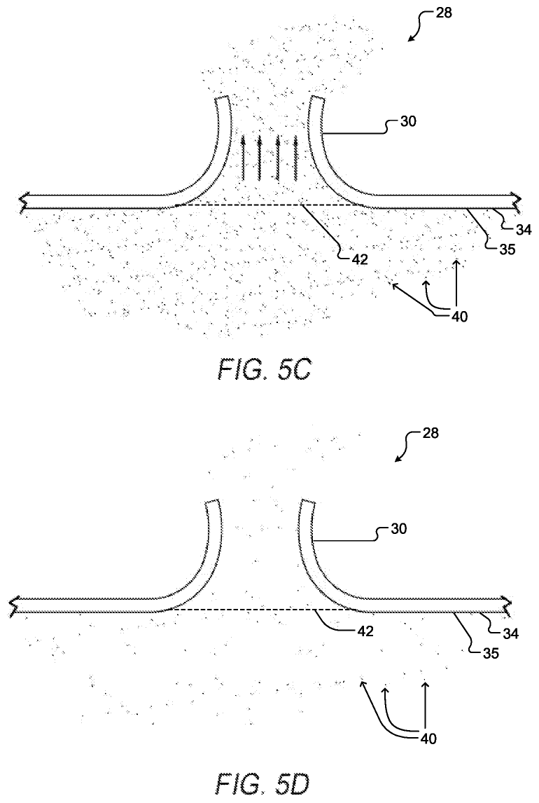

FIGS. 5A-5D schematically illustrate operation of blow-out valve 28. FIG. 5A depicts the blow-out valve 28 in the closed position where pressure within battery pack 18 is below the threshold (e.g., 100 millibars) required to open blow-out valve 28. FIG. 5B depicts the blow-out valve 28 under a pressure that is approaching the gas pressure threshold (e.g., 100 millibars), but where the gases (illustrated as particles 40 for ease of description) are depicted as dense and agitated. In this state, the flexible members 30 can be seen as beginning to deform, rolling upwards and away from the high pressure gas 40 pushing against it. FIG. 5C depicts the blow-out valve 28 under pressure that has exceeded the gas pressure threshold required to open the blow-out valve 28b (e.g., 100 millibars), and the flexible members 30 having moved from the inverted state (FIGS. 5A and 5B) to the open state where the gases 40 are permitted to exit the battery pack 18 through vents 26 and the blow-out valves 28, which rapidly equalizes the pressure in battery pack 18 as shown in FIG. 5D. In this example, damage to the battery and electric vehicle may be avoided or at least substantially minimized. Once the gases have exited the battery pack 18, the faulty cells 22 can be removed therefrom and the blow-out valves 28 may simply be pushed and inverted to once more form the interlocking seal between surfaces 57 of flexible members 30.

The gas pressure threshold of that can trigger opening blow-out valves 28 may be determined by a length L of the planar surfaces 53 of the flexible members 30, and the elasticity of the elastomer used to form the blow-out valves 28. With respect to the length L, the force required to open the blow-out valve 28 is a product of pressure and the area over which it acts. The larger the length L the greater the amount of gas pressure required to move the blow-out valve 28 from the closed position to the open position. Various lengths L, and thus various gas pressure thresholds, are contemplated. In this regard, the threshold can be above or below 100 millibars, if desired.

The gas pressure threshold may be further determined by the elasticity of the elastomer. By adjusting the elasticity of the elastomer, the gas pressure threshold of the blow-out valve 28 may be decreased or increased, respectively. The more elastic material will open at lower pressures, while a less elastic material will require higher pressures.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A valve configured for use with a battery pack having a discharge vent for discharging gases from the battery pack, the valve comprising:
an annular base located proximate the discharge vent and defining a through-hole;
a hollow throat section having a proximate end connected to the annular base at the through-hole and a distal end located away from the annular base; and
a plurality of flexible members attached to the distal end that are configured to mate together to seal the aperture when the valve is in a closed position and configured to separate when the valve is in an open position,
wherein the plurality of flexible members are configured to separate when a pressure within the battery pack reaches a predetermined threshold, and
in a closed position of the valve, the hollow throat section including the flexible members extends away from the through-hole in a negative z-direction, and in an open position of the valve the hollow throat section including the flexible members extend away from the through-hole in a positive z-direction.

2. The valve according to claim 1, wherein each of the plurality of flexible members include edges that are configured to mate and form an interlocked seal when the valve is in the closed position.

3. The valve according to claim 2, wherein the edges separate to open the interlocked seal when the valve is in the open position.

4. The valve according to claim 1, wherein the predetermined threshold to open the valve is about 100 millibars.

5. The valve according to claim 1, wherein each of the annular base, the throat section, and the plurality of flexible members are formed of an elastomeric material.

6. The valve according to claim 5, wherein the elastomeric material is selected from the group consisting of a natural or synthetic rubber material, a silicone material, and polyurethane material.

7. The valve according to claim 1, wherein each of the annular base, the throat section, and each of the plurality of flexible members form a monolithic structure.

8. A battery pack comprising:
a housing configured to support a plurality of battery cells;
a plurality of discharge vents that are configured to discharge gases generated by at least one of the plurality of battery cells; and
a valve provided in each of the discharge vents that is configured to open to permit the discharge gases to escape the housing through each of the discharge vents,
wherein each of the valves includes an annular base located proximate the discharge vent and defining a through-hole;
a hollow throat section having a proximate end connected to the annular base at the through-hole and a distal end located away from the annular base; and
a plurality of flexible members attached to the distal end that are configured to mate together to seal the aperture when the valve is in a closed position and configured to separate when the valve is in an open position,
wherein the plurality of flexible members are configured to separate when a pressure within the battery pack reaches a predetermined threshold, and in a closed position of the valve, the hollow throat section including the flexible members extends away from the through-hole in a negative z-direction, and in an open position of the valve the hollow throat section including.

9. The battery pack according to claim 8, wherein each of the plurality of flexible members include edges that are configured to mate and form an interlocked seal when the valve is in the closed position.

10. The battery pack according to claim 9, wherein the edges separate to open the interlocked seal when the valve is in the open position.

11. The battery pack according to claim 8, wherein the predetermined threshold to open the valve is about 100 millibars.

12. The battery pack according to claim 8, wherein each of the annular base, the throat section, and the plurality of flexible members are formed of an elastomeric material.

13. The battery pack according to claim 12, wherein the elastomeric material is selected from the group consisting of a natural or synthetic rubber material, a silicone material, and polyurethane material.

14. The battery pack according to claim 8, wherein each of the annular base, the throat section, and each of the plurality of flexible members form a monolithic structure.
